(19) United States
(12) Patent Application Publication
(10) Pub. No.: US 2009/0260888 A1
(43) Pub. Date: Oct. 22, 2009

(54) Fiber Reinforced Pressure Compensator Diaphragm

(75) Inventors: Aaron J. Dick, Houston, TX (US); Terry J. Koltermann, The Woodlands, TX (US); Chih Lin, Spring, TX (US); Stefan M. Butuc, The Woodlands, TX (US); Cameron Field-Eaton, Ontario, CA (US)

Correspondence Address: Bracewell & Giuliani LLP, P.O. Box 61389, Houston, TX, 77208-1389, US

(73) Assignee: Baker Hughes Incorporated, Houston, TX (US)

(21) Appl. No.: 12/427,335

(22) Filed: Apr. 21, 2009

Related U.S. Application Data
(60) Provisional application No. 61/046,510, filed on Apr. 21, 2008.

(51) Int. Cl. E21B 10/24; F16N 11/00

(52) U.S. Cl. 175/228; 384/93

(57) ABSTRACT

A drill bit for drilling a wellbore, the drill bit having a body and at least one bearing. A rotary cone is rotatably attached to the bit body at the bearing. A lubricant reservoir is located in an inner portion of the bit body and is in fluid communication with the bearing. A communication port leads from the inner portion of the bit body to the exterior of the bit body. A fiber reinforced elastomeric pressure compensator diaphragm separates lubricant in the lubricant reservoir from the communication port.

### CROSS-REFERENCE TO RELATED APPLICATION

This application claims priority to provisional application 61/046,510, filed Apr. 21, 2008.

### FIELD OF THE INVENTION

This invention relates, in general, to a drill bit used for excavating a subterranean formation. The present invention relates, in particular, to a fiber reinforced pressure compensator diaphragm for use with a drill bit.

### BACKGROUND OF THE INVENTION

Tricone drill bits with sealed bearing systems rely on an elastomeric compensator diaphragm to minimize the pressure differential across the dynamic bearing seal. The elastomeric diaphragm separates lubricant in a lubricant reservoir from a communication port that leads to the exterior of the bit body. The communication port communicates the hydrostatic pressure on the exterior of the bit with the pressure compensator to reduce and preferably equalize the pressure differential between the lubricant and the hydrostatic pressure on the exterior. The exterior side of the diaphragm is exposed to abrasives and pressure fluctuations that can wear and/or tear the diaphragm, leading to leakage and bearing failure.

### SUMMARY OF THE INVENTION

A drill bit for drilling a wellbore has a body with at least one bearing. A rotary cone is rotatably attached to the bit body at the bearing. A lubricant reservoir is located in an inner portion of the bit body and is in fluid communication with the bearing. A communication port leads from the inner portion of the bit body to the exterior of the bit body. A fiber reinforced elastomeric pressure compensator diaphragm separates lubricant in the lubricant reservoir from the communication port. The communication port communicates the hydrostatic pressure on the exterior of the bit with the pressure compensator that in turn communicates the hydrostatic pressure to the lubricant to reduce and preferably equalize the pressure differential between the lubricant and the hydrostatic pressure on the exterior.

The fiber reinforced elastomeric pressure compensator may be comprised of elastomers such as acrylonitrile butadiene elastomers (NBR), hydrogenated nitrile-butadiene elastomers (HNBR), fluorocarbon elastomers (FKM), and perfluoroelastomers (FFKM). The fiber reinforced elastomeric pressure compensator may be comprised of fibers such as polytetrafluoroethene (PTFE) fibers, aromatic polyamide fibers, carbon fibers, slagwool fibers (magnesium calcium aluminum silicates), cellulose fibers, and Zylon (poly p-phenylene-2,6-benzobisoxazole) fibers.

In one embodiment, the fibers are uniformly distributed throughout the compensator diaphragm. In an alternate embodiment, the fibers are selectively distributed in critical high stress areas of the compensator diaphragm, such as the flange and side wall areas. In another embodiment, the fibers are preferentially oriented in the direction of the tensile stress.

### BRIEF DESCRIPTION OF THE DRAWINGS

FIG. 1 is cross sectional view of a portion of an earth boring drill bit constructed in accordance with this invention.

FIG. 2 is an isometric view of the fiber reinforced pressure compensator diaphragm.

FIG. 3 is a cross sectional view of the fiber reinforced pressure compensator diaphragm of FIG. 2.

### DETAILED DESCRIPTION OF THE INVENTION

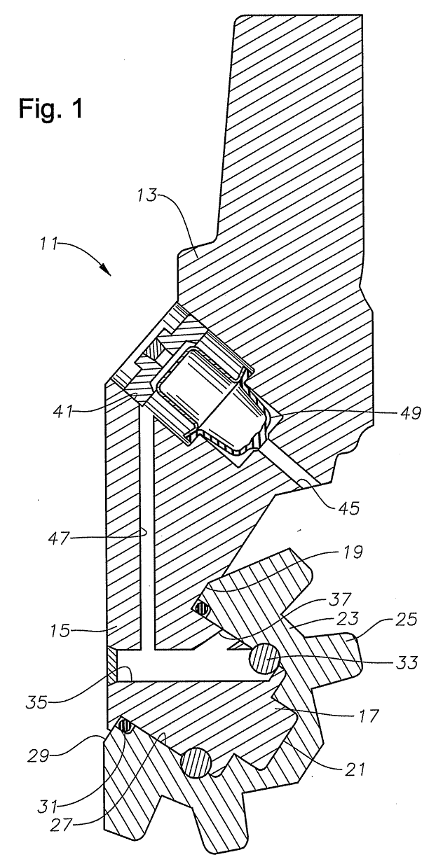

Referring to FIG. 1, a bit 11 has a body 13 at an upper end that is threaded (not shown) for attachment to the lower end of a drill string. Body 13 has at least one bit leg 15, typically three, which extends downward from it. Each bit leg 15 has a bearing pin 17 that extends downward and inward. Bearing pin 17 has an outer end, referred to as a last machined surface 19, where it joins bit leg 15. Bearing pin 17 has a cylindrical journal surface and a smaller diameter formed on its inner end.

A rotary cutter cone 23 is rotatably attached to the bearing pin 17. The cone 23 may be retained in more than one manner. In this embodiment, cone 23 is retained on bearing pin 17 by a plurality of balls 33 that engage a mating annular recess formed in a cone cavity 27 and on bearing pin 17. Balls 33 lock cone 23 to bearing pin 17 and are inserted through a ball passage 35 during assembly after cone 23 is placed on bearing pin 17. Ball passage 35 extends to the exterior of bit leg 15 and is plugged after balls 33 are installed.

A portion of cavity 27 slidingly engages the journal surface (not visible). The outer end of the journal surface is considered to be at the junction with the gland area, which is engaged by a seal 31. The inner end of the journal surface is considered to be at the junction with the groove or race for balls 33. The journal surface serves as a journal bearing for axial loads imposed on bit 11.

A lubricant port 37 is located on an exterior portion of the journal surface of bearing pin 17. Lubricant port 37 is connected to a passage 47 via ball passage 35. Passage 47 leads to a lubricant reservoir 41. A lubricant resides in the lubricant reservoir 41, the passage 47, the ball passage 35, lubricant port 37, and in the space between the cone cavity 27 and bearing pin 17.

In lubricant reservoir 41, a fiber reinforced elastomeric pressure compensator diaphragm 49 separates lubricant in lubricant reservoir 41 from a communication port 45 that leads to the exterior of bit body 13. Communication port 45 communicates the hydrostatic pressure on the exterior of bit 11 to the pressure compensator 49 that in turn communicates the hydrostatic pressure to the lubricant and thus to the inner portion of the bit 11. This reduces and preferably equalizes the pressure differential between the lubricant and the hydrostatic pressure on the exterior, thereby minimizing the pressure differential across the seal 31.

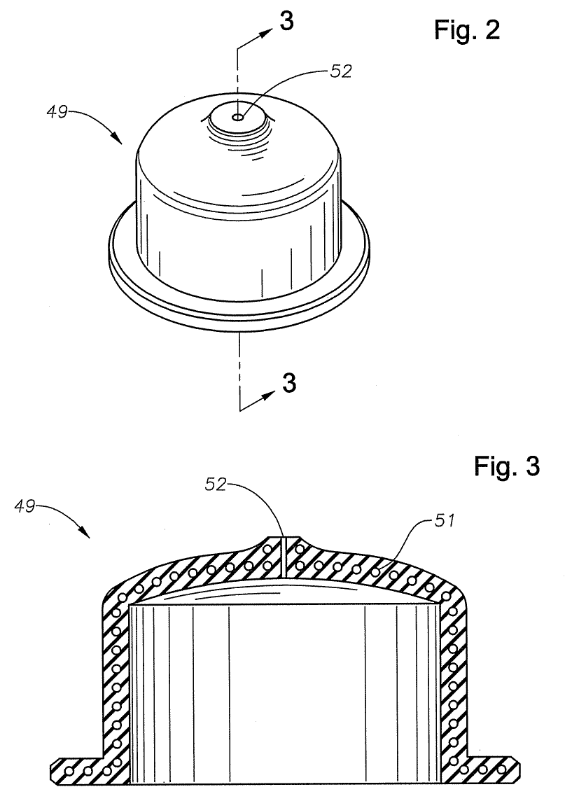

Referring to FIG. 2, this embodiment of the pressure compensator diaphragm 49 has a general cup like shape with a closed end and an open end. The closed end includes an optional pin hole 52 formed therethrough. The compensator diaphragm 49 can be constructed from various elastomeric compounds, including: acrylonitrile butadiene elastomers (NBR), hydrogenated nitrile-butadiene elastomers (HNBR), fluorocarbon elastomers (FKM), and perfluoroelastomers (FFKM). FFKM as designated in ASTM D1418-06 are “perfluorinated rubbers of the polymethylene type having all fluoro, perfluroalkyl, or perfluoroalkyoxy substituent groups on the polymer chain; a small fraction of this group may contain functionality to facilitate vulcanization.” According to ASTM D1418-06, “FKM is a fluoro rubber of the polymethylene type that utilizes vinylidene fluoride as a comonomer and has substituent fluoro, alkyl, perfluoroalkyl or perfluroalkyoxy groups on the polymer chain; with or without the cure site monomer.”

Referring to FIG. 3, the compensator diaphragm 49 is shown in a cross sectional view. In this embodiment, fiber particles 51 are included within the compensator diaphragm 49. The fiber particles 51 may be used to improve abrasion resistance and tear strength. In this particular embodiment the fiber particles 51 are uniformly distributed throughout the diaphragm 49. In an alternate embodiment, fiber particles 51 may be selectively distributed in critical high stress areas of the compensator diaphragm 49, such as the flange and side wall areas. Examples of fiber particles 51 include: polytetrafluoroethene (PTFE) fibers, aromatic polyamide fibers, carbon fibers, slagwool fibers (magnesium calcium aluminum silicates), cellulose fibers, and Zylon fibers. When reinforced with the various fibers, the elastomer compounds demonstrate improved tear strength and abrasion resistance. The fiber particles 51 are not woven, but rather comprise small individual strands.

The loading for the compensator 49 may be up to 75 parts fiber per 100 parts of elastomer. The loading for the compensator 49 may be as low as 0.05 parts fiber per 100 parts of elastomer. In one example, the loading for the compensator 49 may be 0.05 to 3 parts fiber per 100 parts of elastomer. In another example, the loading for the compensator 49 may be 3 to 10 parts fiber per 100 parts of elastomer. In another example, the loading for compensator 49 may be 10 to 40 parts fiber per 100 parts of elastomer. In another example, the loading for compensator 49 may be 40 to 75 parts fiber per 100 parts of elastomer. The loading for compensator 49 may range anywhere from the lower value of 0.05 parts fiber per 100 parts of elastomer, to the upper value of 75 parts fiber per 100 parts of elastomer. The fiber particles may be treated with a surfactant or bonding agent prior to being added to the elastomeric compound. The surfactant may act as a wetting agent assist with and improve the dispersion of the fiber particles throughout the elastomeric compound. The bonding agent may improve the bond strength between the elastomeric compound and the fiber particles.

In one example, slagwool fibers are distributed throughout the elastomeric compensator diaphragm 49. The slagwool fibers may have: average diameters that range from 4 to 6 μm, average fiber lengths from 0.1 to 4.0 mm, and a tensile strength of 3.5 GPa. The slagwool fibers have an approximate density of 2.6 g/cm³. In an alternate embodiment, fiber lengths may be up to 1.4 cm.

In another example, carbon fibers are distributed throughout the elastomeric compensator diaphragm 49. The carbon fibers may be chopped or milled and have diameters that range from 7 to 15 μm, and tensile strengths from 0.2 to 3.9 GPa. The carbon fibers range in density from 1.3 to 1.9 g/cm³. Chopped carbon fiber lengths range from 3 to 25 mm. Milled carbon fiber lengths range from 150 to 1600 μm. In an alternate embodiment, fiber lengths may be up to 1.4 cm.

In another example, Zylon fibers are distributed throughout the elastomeric compensator diaphragm 49. Zylon is a thermoset polyurethane synthetic polymer material. The Zylon fibers range in density from 1.5 to 1.6 g/cm³ and have a tensile strength of 5.8 GPa. In an alternate embodiment, fiber lengths may be up to 1.4 cm.

In another example, cellulose fibers are distributed throughout the elastomeric diaphragm 49. The cellulose fibers range in density from 1.0 to 1.4 g/cm³. The cellulose fiber diameters are typically 20 μm. In an alternate embodiment, fiber lengths may be up to 1.4 cm.

In one embodiment, aramid (i.e. aromatic polyamide) fibers are dispersed throughout a FKM compensator diaphragm 49. The fibers have an approximate fiber diameter of 12 μm, and length from 1 to 2 mm. In an alternate embodiment, fiber lengths may be up to 1.4 cm. To facilitate preparation of the FKM compound for the compensator, a high aramid fiber content elastomer mixture is first prepared. Portions of this high fiber content elastomer mixture, along with other ingredients in the FKM compensator compound recipe, are blended together using standard elastomer compound mixing practices to form a batch of the FKM compensator compound in the uncured state. The result is a near homogeneous distribution of the aramid fiber in the elastomer compound. The finished compensator part is then produced by placing a portion of the uncured FKM compound in a mold where heat and pressure are utilized to produce a compensator composed of the cured FKM compound with the improved properties of this invention. The aramid fiber content of the FKM compound will account for two percent of the total weight of the compensator.

The invention has significant advantages. By forming an elastomeric pressure compensator diaphragm reinforced with fiber particles, the abrasion and tear resistance of the compensator diaphragm are improved. By blending high temperature elastomeric compounds with fiber particles, abrasion and tear strength are improved without sacrificing the high temperature properties of the compensator diaphragm.

While the invention has been shown in only a few of its forms, it should be apparent to those skilled in the art that it is not so limited, but is susceptible to various changes without departing from the scope of the invention.

1. A drill bit for drilling a wellbore, the drill bit comprising:
a body having at least one bearing;
a rotary cone rotatably attached to the body at the at least one bearing;
a lubricant reservoir located in an inner portion of the body, the reservoir being in fluid communication with the bearing;
a communication port that leads from the inner portion of the body to the exterior of the body; and
a pressure compensator diaphragm that separates lubricant in the lubricant reservoir from the communication port, the diaphragm being formed of an elastomeric material having fiber particles dispersed therein.

2. The drill bit according to claim 1, wherein the fiber particles are uniformly distributed throughout the elastomeric material of the compensator diaphragm.

3. The drill bit according to claim 1, wherein the fiber particles are oriented in the direction of tensile stress on the diaphragm.

4. The drill bit according to claim 1, wherein the diaphragm has a flange and a side wall, and the concentration of fiber particles in the flange and side wall areas is greater than in other areas of the diaphragm.

5. The drill bit according to claim 1, wherein the elastomeric material consists of an elastomer selected from the group consisting of acrylonitrile butadiene elastomers (NBR), hydrogenated nitrile-butadiene elastomers (HNBR), fluorocarbon elastomers (FKM), and perfluoroelastomers (FFKM).

6. The drill bit according to claim 1, wherein the fibers particles consist of a fiber selected from the group consisting of polytetrafluoroethene (PTFE) fibers, aromatic polyamide fibers, carbon fibers, slagwool fibers (magnesium calcium aluminum silicates), cellulose fibers, and Zylon (pol p-phenylene-2,6-benzobisoxazole) fibers.

7. The drill bit according to claim 1, wherein:
the elastomeric material comprises a fluorocarbon elastomer (FKM); and
the fiber particles comprise aromatic polyamide fibers.

8. The drill bit according to claim 1, wherein the fiber particle content in the elastomeric material is in the range from 0.05 parts fiber particles for 100 parts elastomeric material to 75 parts fiber particles for 100 parts elastomeric material.

9. The drill bit according to claim 1, wherein the fiber particles are coated with a surfactant.

10. The drill bit according to claim 1, wherein the fiber particles are coated with a bonding agent.

11. A compensator diaphragm for use with an earth-boring drill bit, the compensator diaphragm comprising:
an elastomeric compound; and
fiber particles dispersed within the elastomeric compound.

12. The diaphragm according to claim 11, wherein the fiber particles are uniformly distributed throughout the compensator diaphragm.

13. The diaphragm according to claim 11, wherein:
the elastomeric compound is a fluorocarbon elastomer (FKM); and
the fiber particles are aromatic polyamide fibers.

14. The diaphragm according to claim 11, wherein the diaphragm has a flange and a side wall, and the concentration of fiber particles in the flange and side wall areas is greater than in other areas of the diaphragm.

15. The drill bit according to claim 11, wherein the fiber particles are oriented in the direction of tensile stress on the diaphragm.

16. The drill bit according to claim 11, wherein the elastomeric compound consists of an elastomer selected from the group consisting of acrylonitrile butadiene elastomers (NBR), hydrogenated nitrile-butadiene elastomers (HNBR), fluorocarbon elastomers (FKM), and perfluoroelastomers (FFKM).

17. The drill bit according to claim 11, wherein the fiber particles consist of a fiber selected from the group consisting of polytetrafluoroethene (PTFE) fibers, aromatic polyamide fibers, carbon fibers, slagwool fibers (magnesium calcium aluminum silicates), cellulose fibers, and Zylon (poly p-phenylene-2,6-benzobisoxazole) fibers.

18. The drill bit according to claim 11, wherein the fiber particle lengths may be as long as 1.4 cm.

19. A drill bit for drilling a wellbore, the drill bit comprising:
a body having at least one bearing;
a rotary cone rotatably attached to the body at the at least one bearing;
a lubricant reservoir located in an inner portion of the body, the reservoir being in fluid communication with the bearing;
a communication port that leads from the inner portion of the body to the exterior of the body; and
a pressure compensator diaphragm that separates lubricant in the lubricant reservoir from the communication port, the diaphragm being formed of a fluorocarbon elastomer (FKM) material having aromatic polyamide fiber particles dispersed therein.

20. The diaphragm according to claim 19, wherein the fiber particles are uniformly distributed throughout the compensator diaphragm.
